(19) United States
(12) Patent Application Publication
(10) Pub. No.: US 2025/0181999 A1
(43) Pub. Date: Jun. 5, 2025

(54) METHOD AND SYSTEM FOR GENERATING FAIR SYNTHETIC REPRESENTATIVE DATA VIA OPTIMAL TRANSPORT

(71) Applicant: JPMorgan Chase Bank, N.A., New York, NY (US)

(72) Inventors: Niccolo DALMASSO, Long Island City, NY (US); Zikai XIONG, Cambridge, MA (US); Vamsi Krishna POTLURU, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/524,760

(22) Filed: Nov. 30, 2023

(51) Int. Cl. G06Q 10/04; G06F 16/31

(52) U.S. Cl. CPC G06Q 10/04; G06F 16/313

(57) ABSTRACT

A method and a system for generating synthetic data that corresponds to an original dataset while maintaining demographic parity are provided. The method includes: receiving a first dataset of original data points, each original data point including a first coordinate that relates to sensitive demographic features, a second coordinate that relates to decision-making features, and a third coordinate that relates to a decision outcome; determining a demographic parity constraint to be applied to the first dataset; generating a second dataset of synthetic data points, each of which includes the first, second, and third coordinates; computing sample-level weights for the synthetic data points; and generating a third dataset by applying the sample-level weights to the second dataset. The computation of the weights includes minimizing the Wasserstein distance between the first dataset and a weighted version of the second dataset while satisfying the demographic parity constraint.

### BACKGROUND

### 1. Field of the Disclosure

This technology generally relates to methods and systems for generating fair synthetic representative data to be used as training data for a machine learning model, and more particularly to methods and systems for generating synthetic data to be used for downstream learning and training tasks in a manner that accurately represents an original dataset while maintaining demographic parity.

### 2. Background Information

In recent years, the rapid pace of technological advancement has provided the ability of collecting, storing and processing massive amounts of data from multiple sources. As the volume of data continues to surge, it often surpasses both the available computational resources as well as the capacity of machine learning algorithms. In response to this limitation, dataset distillation approaches aim to reduce the amount of data by creating a smaller, yet representative, set of samples. Among those approaches, coresets provide a weighted subset of the original data that achieves similar performance to the original dataset in what is usually a specific machine learning task, such as clustering, Bayesian inference, online learning, and classification, among others.

In tandem with these developments, the adoption of machine learning techniques has seen a surge in multiple decision-making processes that affect society at large. This proliferation of machine learning applications has highlighted the need to mitigate inherent biases in the data, as these biases can significantly impact the equity of machine learning models and their decisions. Among many definitions of algorithmic fairness, demographic parity is one of the most prominently used metrics, enforcing the distribution of an outcome of a machine learning model to not differ dramatically across different subgroups in the data.

Conventional methodologies for generating a smaller set of fair representative samples typically focus on the local characteristics of these samples with respect to the original dataset. For instance, one approach enforces representative points obtained by clustering to maintain the same proportion of points from each subgroup in each cluster. In another approach, there is a creation of representative points by ensuring that points in the original dataset each have at least one representative point within a given distance in the feature space. While these methods can successfully reduce clustering cost and ensure a more evenly spread-out distribution of representative points in the feature space, it is unclear whether such representative samples can positively affect performance or discrimination reduction in downstream learning processes. As the induced distribution of the representative points might be far away from the original dataset distribution, downstream machine learning algorithms might lose significant performance without necessarily reducing biases in the original data.

Accordingly, there is a need for a method for generating synthetic data to be used for downstream learning and training tasks in a manner that accurately represents an original dataset while maintaining demographic parity.

### SUMMARY

The present disclosure, through one or more of its various aspects, embodiments, and/or specific features or sub-components, provides, inter alia, various systems, servers, devices, methods, media, programs, and platforms for generating synthetic data to be used for downstream learning and training tasks in a manner that accurately represents an original dataset while maintaining demographic parity.

According to an aspect of the present disclosure, a method for generating synthetic data that corresponds to an original dataset while maintaining demographic parity is provided. The method is implemented by at least one processor. The method includes: receiving, by the at least one processor, a first dataset that includes a plurality of original data points, each respective original data point including a first coordinate that relates to sensitive demographic features, a second coordinate that relates to decision-making features, and a third coordinate that relates to a decision outcome that is generated by a machine learning model; determining, by the at least one processor, a demographic parity constraint to be applied to the first dataset; generating, by the at least one processor, a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model; computing, by the at least one processor, a set of respective sample-level weights that correspond to each synthetic data point included in the plurality of synthetic data points; and generating, by the at least one processor, a third dataset by applying the set of respective sample-level weights to the second dataset. The computing of the set of respective sample-level weights includes minimizing, by the at least one processor, a Wasserstein distance between the first dataset and a weighted version of the second dataset while satisfying the demographic parity constraint.

The first dataset may include a first predetermined number of data points that is equal to N. Each of the second dataset and the third dataset may include a second predetermined number of data points that is equal to M. N may be greater than M by at least a factor of ten.

The determining of the demographic parity constraint may include selecting a maximum fairness violation threshold value that relates to a distance between a conditional distribution of the third dataset with respect to the third coordinate and a target distribution of the first dataset with respect to the third coordinate.

The method may further include reformulating the minimizing of the Wasserstein distance as a linear program (LP).

The method may further include performing the minimizing of the Wasserstein distance by applying a predetermined majority minimization algorithm to the LP.

The machine learning model may be configured to use an artificial intelligence technique for making a decision based on input data that relates to a person. The decision may relate to at least one from among a consumer finance question, a health insurance question, and a hiring question.

The sensitive demographic features may include at least one from among race, gender, national origin, and disability.

The decision-making features may include at least one from among a level of education, a grade point average (GPA), and a level of income.

The first dataset may include one from among an Adult dataset, a German Credit dataset, a Communities and Crime dataset, and a Drug dataset.

According to another exemplary embodiment, a computing apparatus for generating synthetic data that corresponds to an original dataset while maintaining demographic parity is provided. The computing apparatus includes a processor; a memory; and a communication interface coupled to each of the processor and the memory. The processor is configured to: receive, via the communication interface, a first dataset that includes a plurality of original data points, each respective original data point including a first coordinate that relates to sensitive demographic features, a second coordinate that relates to decision-making features, and a third coordinate that relates to a decision outcome that is generated by a machine learning model; determine a demographic parity constraint to be applied to the first dataset; generate a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model; compute a set of respective sample-level weights that correspond to each synthetic data point included in the plurality of synthetic data points; and generate a third dataset by applying the set of respective sample-level weights to the second dataset. The computation of the set of respective sample-level weights includes minimizing a Wasserstein distance between the first dataset and a weighted version of the second dataset while satisfying the demographic parity constraint.

The first dataset may include a first predetermined number of data points that is equal to N. Each of the second dataset and the third dataset may include a second predetermined number of data points that is equal to M. N may be greater than M by at least a factor of ten.

The processor may be further configured to determine the demographic parity constraint by selecting a maximum fairness violation threshold value that relates to a distance between a conditional distribution of the third dataset with respect to the third coordinate and a target distribution of the first dataset with respect to the third coordinate.

The processor may be further configured to reformulate the minimization of the Wasserstein distance as a linear program (LP).

The processor may be further configured to performing the minimization of the Wasserstein distance by applying a predetermined majority minimization algorithm to the LP.

The machine learning model is configured to use an artificial intelligence technique for making a decision based on input data that relates to a person. The decision may relate to at least one from among a consumer finance question, a health insurance question, and a hiring question.

The sensitive demographic features may include at least one from among race, gender, national origin, and disability.

The decision-making features may include at least one from among a level of education, a grade point average (GPA), and a level of income.

The first dataset may include one from among an Adult dataset, a German Credit dataset, a Communities and Crime dataset, and a Drug dataset.

According to yet another exemplary embodiment, a non-transitory computer readable storage medium storing instructions for generating synthetic data that corresponds to an original dataset while maintaining demographic parity is provided. The storage medium includes executable code which, when executed by a processor, causes the processor to: receive a first dataset that includes a plurality of original data points, each respective original data point including a first coordinate that relates to sensitive demographic features, a second coordinate that relates to decision-making features, and a third coordinate that relates to a decision outcome that is generated by a machine learning model; determine a demographic parity constraint to be applied to the first dataset; generate a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model; compute a set of respective sample-level weights that correspond to each synthetic data point included in the plurality of synthetic data points; and generate a third dataset by applying the set of respective sample-level weights to the second dataset. The computation of the set of respective sample weights includes minimizing a Wasserstein distance between the first dataset and a weighted version of the second dataset while satisfying the demographic parity constraint.

The first dataset may include a first predetermined number of data points that is equal to N. Each of the second dataset and the third dataset may include a second predetermined number of data points that is equal to M. N may be greater than M by at least a factor of ten.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating synthetic data to be used for downstream learning and training tasks in a manner that accurately represents an original dataset while maintaining demographic parity.

FIG. 4 is a flowchart of an exemplary process for implementing a method for generating synthetic data to be used for downstream learning and training tasks in a manner that accurately represents an original dataset while maintaining demographic parity.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

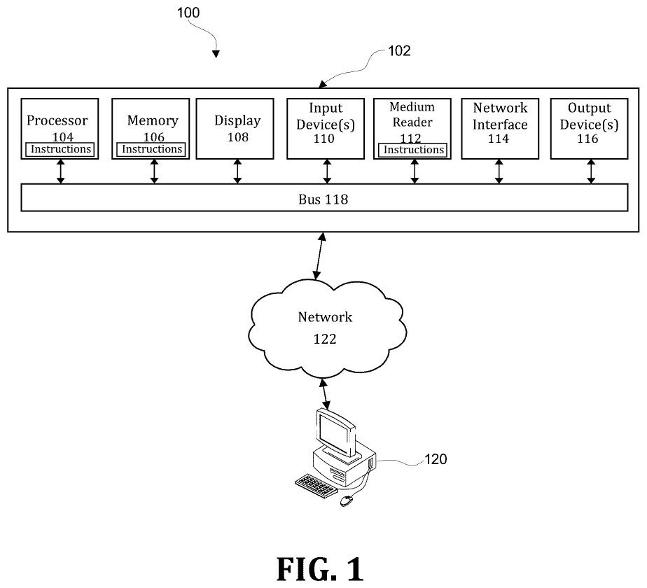

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating synthetic data to be used for downstream learning and training tasks in a manner that accurately represents an original dataset while maintaining demographic parity.

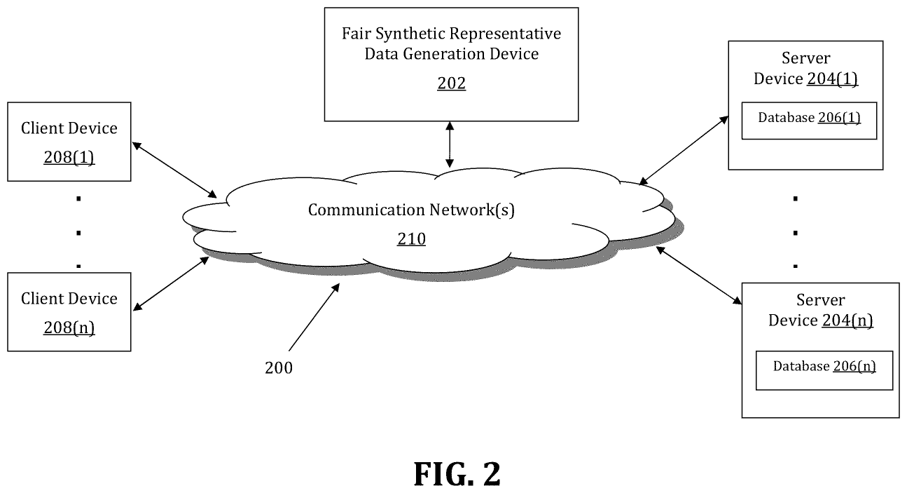

Referring to FIG. 2, a schematic of an exemplary network environment 200 for implementing a method for generating synthetic data to be used for downstream learning and training tasks in a manner that accurately represents an original dataset while maintaining demographic parity is illustrated. In an exemplary embodiment, the method is executable on any networked computer platform, such as, for example, a personal computer (PC).

The method for generating synthetic data to be used for downstream learning and training tasks in a manner that accurately represents an original dataset while maintaining demographic parity may be implemented by a Fair Synthetic Representative Data Generation (FSRDG) device 202. The FSRDG device 202 may be the same or similar to the computer system 102 as described with respect to FIG. 1. The FSRDG device 202 may store one or more applications that can include executable instructions that, when executed by the FSRDG device 202, cause the FSRDG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the FSRDG device 202 itself, may be located in virtual server(s) running in a cloud-based computing environment rather than being tied to one or more specific physical network computing devices. Also, the application(s) may be running in one or more virtual machines (VMs) executing on the FSRDG device 202. Additionally, in one or more embodiments of this technology, virtual machine(s) running on the FSRDG device 202 may be managed or supervised by a hypervisor.

In the network environment 200 of FIG. 2, the FSRDG device 202 is coupled to a plurality of server devices 204(1)-204(n) that hosts a plurality of databases 206(1)-206 (n), and also to a plurality of client devices 208(1)-208(n) via communication network(s) 210. A communication interface of the FSRDG device 202, such as the network interface 114 of the computer system 102 of FIG. 1, operatively couples and communicates between the FSRDG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FSRDG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and FSRDG devices that efficiently implement a method for generating synthetic data to be used for downstream learning and training tasks in a manner that accurately represents an original dataset while maintaining demographic parity.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The FSRDG device 202 may be a standalone device or integrated with one or more other devices or apparatuses, such as one or more of the server devices 204(1)-204(n), for example. In one particular example, the FSRDG device 202 may include or be hosted by one of the server devices 204(1)-204(n), and other arrangements are also possible. Moreover, one or more of the devices of the FSRDG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the FSRDG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical information that relates to demographic distributions in various groups and information that relates to metrics for demographic disparity and/or unfairness.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the FSRDG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the FSRDG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the FSRDG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the FSRDG device 202, the server devices 204(1)-204(n), or the client devices 208(1)-208(n), for example, may be configured to operate as virtual instances on the same physical machine. In other words, one or more of the FSRDG device 202, the server devices 204(1)-204(n), or the client devices 208(1)-208(n) may operate on the same physical device rather than as separate devices communicating through communication network(s) 210. Additionally, there may be more or fewer FSRDG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

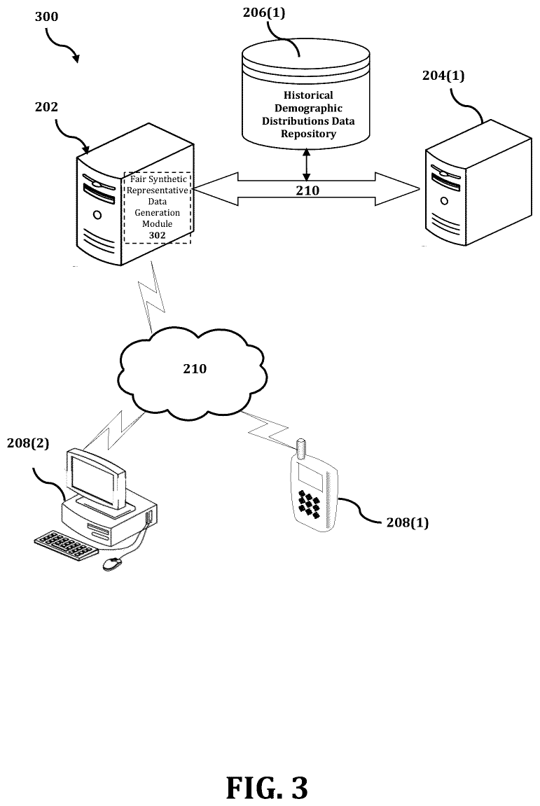

The FSRDG device 202 is described and illustrated in FIG. 3 as including a fair synthetic representative data generation module 302, although it may include other rules, policies, modules, databases, or applications, for example. As will be described below, the fair synthetic representative data generation module 302 is configured to implement a method for generating synthetic data to be used for downstream learning and training tasks in a manner that accurately represents an original dataset while maintaining demographic parity.

An exemplary process 300 for implementing a mechanism for generating synthetic data to be used for downstream learning and training tasks in a manner that accurately represents an original dataset while maintaining demographic parity by utilizing the network environment of FIG. 2 is illustrated as being executed in FIG. 3. Specifically, a first client device 208(1) and a second client device 208(2) are illustrated as being in communication with FSRDG device 202. In this regard, the first client device 208(1) and the second client device 208(2) may be “clients” of the FSRDG device 202 and are described herein as such. Nevertheless, it is to be known and understood that the first client device 208(1) and/or the second client device 208(2) need not necessarily be “clients” of the FSRDG device 202, or any entity described in association therewith herein. Any additional or alternative relationship may exist between either or both of the first client device 208(1) and the second client device 208(2) and the FSRDG device 202, or no relationship may exist.

Further, FSRDG device 202 is illustrated as being able to access a historical demographic distributions data repository 206(1). The fair synthetic representative data generation module 302 may be configured to access this and other databases for implementing a method for generating synthetic data to be used for downstream learning and training tasks in a manner that accurately represents an original dataset while maintaining demographic parity.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the FSRDG device 202 via broadband or cellular communication. Of course, these embodiments are merely exemplary and are not limiting or exhaustive.

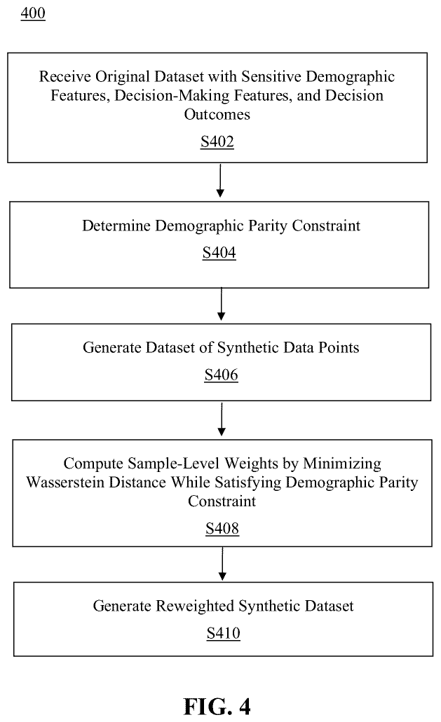

Upon being started, the fair synthetic representative data generation module 302 executes a process for generating synthetic data to be used for downstream learning and training tasks in a manner that accurately represents an original dataset while maintaining demographic parity. An exemplary process for generating synthetic data to be used for downstream learning and training tasks in a manner that accurately represents an original dataset while maintaining demographic parity is generally indicated at flowchart 400 in FIG. 4.

In process 400 of FIG. 4, at step S402, the fair synthetic representative data generation module 302 receives a first dataset that includes a set of original data points. Each original data point has at least three coordinates: a first coordinate that relates to sensitive demographic features; a second coordinate that relates to decision-making features; and a third coordinate that relates to a decision outcome that is generated by a machine learning (ML) model. In an exemplary embodiment, the ML model is configured to use an artificial intelligence (AI) technique for making a decision based on input data that relates to a person. The decision may relate to a consumer finance question, a health question, a hiring question, and/or any other type of question that relates to the person.

In an exemplary embodiment, the sensitive demographic features may include any one or more of race, gender, national origin, and disability. In an exemplary embodiment, the decision-making features may include any one or more of a level of education, a grade point average (GPA), and a level of income. In an exemplary embodiment, the first dataset may be any one of an Adult dataset, a German Credit dataset, a Communities and Crime dataset, or a Drug dataset.

At step S404, the fair synthetic representative data generation module 302 the fair synthetic representative data generation module 302 determines a demographic parity constraint to be applied to the first dataset. In an exemplary embodiment, the determination of the demographic parity constraint is made by selecting a maximum fairness violation threshold value that relates to a distance between a conditional distribution of a weighted version of a synthetic dataset to be generated and a target distribution of the first dataset with respect to the third coordinate.

At step S406, the fair synthetic representative data generation module 302 generates a second dataset that includes a set of synthetic data points. In an exemplary embodiment, each synthetic data point also has at least the same three coordinates, i.e., the first coordinate that relates to the sensitive demographic features; the second coordinate that relates to the decision-making features; and the third coordinate that relates to the decision outcome that is generated by the ML model. In an exemplary embodiment, the first dataset may include a predetermined number of data points that is equal to N, and the second dataset may include a predetermined number of data points that is equal to M, such that N is much greater than M. For example, N may be greater than M by at least a factor of ten, a factor of 100, or a factor of 1000.

At step S408, the fair synthetic representative data generation computes a set of sample-level weights that correspond to each synthetic data point included in the second dataset generated in step S406. Then, at step S410, the fair synthetic representative data generation module 302 generates a third dataset, i.e., a reweighted synthetic dataset, by applying each respective sample-level weight to the corresponding synthetic data from the second dataset. In an exemplary embodiment, step S406 and step S408 are performed simultaneously by using an optimization algorithm, to be described further below.

In an exemplary embodiment, the fair synthetic representative data generation module 302 performs the computation of the set of respective sample-level weights by minimizing a Wasserstein distance between the first dataset and a weighted version of the second dataset while satisfying the demographic parity constraint. In an exemplary embodiment, the minimization of the Wasserstein distance may be implemented by performing the following operations: reformulating the minimization as a linear program (LP); and performing the minimization by applying a predetermined majority minimization algorithm to the LP.

Recent technological advancements have given rise to the ability of collecting vast amounts of data, that often exceed the capacity of commonly used machine learning algorithms. Approaches such as coresets and synthetic data distillation have emerged as frameworks to generate a smaller, yet representative, set of samples for downstream training. As machine learning is increasingly applied to decision-making processes, it becomes imperative for modelers to consider and address biases in the data concerning subgroups defined by factors like race, gender, or other sensitive attributes.

In an exemplary embodiment, there is an introduction of Fair Wasserstein Coresets (FWC), a novel coreset approach that not only generates synthetic representative samples but also assigns sample-level weights to be used in downstream learning tasks. One key objective of FWC is generating synthetic samples by minimizing the Wasserstein distance between the distribution of the original datasets and that of the weighted synthetic samples, while simultaneously enforcing an empirical version of demographic parity. The Wasserstein distance is particularly useful when generating coresets, as downstream model performance is tied to the Wasserstein distance's dual formulation. A description is provided below for the minimization problem in which demographic parity is introduced via linear constraint, and this description shows that the problem can be solved by first reformulating the objective function and then using a majority minimization algorithm. In addition, it is shown how the unconstrained version of FWC is equivalent to Lloyd's algorithm for k-means and k-medians clustering, extending its applicability beyond fairness applications.

Notation: In an exemplary embodiment, the original dataset samples are denoted as {Zᵢ}ᵢ₌₁ⁿ, with Zᵢ=(Dᵢ, Xᵢ, Yᵢ)∈Z=(D×X×Y). In this context, D represents one or more sensitive features such as gender or race, X denotes the non-sensitive features, and Y is a discrete decision outcome. Given a set of weights {θ}ᵢ₌₁ⁿ, a definition of p_{Z;θ}, i.e., the weighted distribution of a dataset

$${\{ {Z}_{i} \}}_{i = 1}^{n} as {p}_{Z} \text{?} {=}^{def .} \frac{1}{n} {\sum }_{i = 1}^{n} {θ}_{i} {δ}_{{Z}_{i}} ,$$

$$\text{?} \text{indicates text missing or illegible when filed}$$

where δ_{X} stands for the Dirac unit mass distribution at point x∈X. In this notation, the empirical distribution of the original dataset can be written by setting θᵢ=eᵢ=1 for any i, i.e.,

$${p}_{Z ; e} = \frac{1}{n} {\sum }_{i = 1}^{n} {e}_{i} {δ}_{{Z}_{i}} .$$

For a matrix A, A^{T} denotes its transpose. For two vectors or matrices [symbol] u, v [symbol] ^{def.}=Pᵢuᵢvᵢ is the canonical inner product, i.e., the Frobenius dot-product for matrices. A definition of

$${1}_{m} {=}^{def .} ( 1 , … , 1 ) ∈ {ℝ}_{+}^{m}$$

is provided. The expression [symbol] ¹+( [symbol] ) denotes the set of probability distributions over a metric space X.

Measure Coreset: Let F be the hypothesis set for a learning problem. Every function ƒ∈F maps from Z to R. In an exemplary embodiment, it is said that a weighted dataset {\hat{Z}ₗ=(\hat{X}ₗ, \hat{D}ₗ, Ŷₗ), θᵢ}^{m}ᵢ₌₁ is an ϵ-coreset if

$$( Expression 1 )$$

$${sup}_{\int ∈ ℱ} \vert cost ( Z , w , f ) − cost ( \hat{Z} , θ , f ) \vert \leq ϵ , where cost ( Z , w , f ) = {\sum }_{i = 1}^{n} {w}_{i} f ( {Z}_{i} ) .$$

In this definition, finding an ϵ-coreset corresponds to obtaining a weighted compressed dataset {\hat{Z}ᵢ, θᵢ}ᵢ₌₁^{m} such that m<<n and with a small ϵ. This definition of ϵ-coreset highlights the importance of preserving the performance of downstream learning models on the original dataset {Zᵢ}ᵢ₌₁ⁿ.

Wasserstein Distance: The general Wasserstein distance, also referred to herein as optimal transport metric, between two probability distributions (μ, v)∈ [symbol] ¹+( [symbol] )× [symbol] ¹+( [symbol] ) supported on two metric spaces (X, X) is defined as the optimal objective of the possibly infinite-dimensional linear program (LP):

$${W}_{c} ( μ , v ) {=}^{def .} {min}_{π ∈ \prod ( μ , v )} {\int }_{𝒳 \times 𝒳} c ( x , y ) d π ( x , y ) , \qquad ( Expression 2 )$$

where Π(μ, v) is the set of couplings composed of joint probability distributions over the product space X×X with imposed marginals (μ, v). Expression 2 is also called the Kantorovitch formulation of optimal transport. Here, c(x, y) represents the “cost” to move a unit of mass from x to y. A typical choice in space X with metric d_{X} is c(x, y)=d_{X}(x, y)^{p} for p≥1, and then W_{c}^{1/p} corresponds to the p-Wasserstein distance between probability measures. Using the Wasserstein distance between distributions is particularly useful as it provides a bound for functions applied to samples from those distributions. In other words, the following deviation is defined as follows:

$$d ( μ , v ) {=}^{def .} sup \vert {E}_{z ∼ μ} f ( z ) − {E}_{z ∼ v} f ( z ) \vert , f ∈ F$$

where F is a family of functions ƒ. If F=Lip₁, the class of Lipschitz-continuous functions with Lipschitz constant of 1, the deviation d (μ, v) is equal to the 1-Wasserstein distance. Analog bounds can be derived for the 2-Wasserstein distance when [symbol] ={ƒ|∥ƒ∥s¹(μ)≤1} the class of functions with unitary norm over the Sobolev space S={ƒ∈L²|∂ₓ_{ᵢ}ƒ∈L²} This fact provides a theoretical intuition for evaluating the quality of a coreset. The closer the Wasserstein distance between the empirical distribution formed by the coreset and the one formed by the original dataset, then the smaller the left-hand side of Expression (2.1) could be.

Demographic Parity: Demographic parity (DP), or statistical parity, requires the outcome variable and sensitive features to be independent, and is arguably the most widely studied fairness criterion to date. In an exemplary embodiment, demographic parity is defined so as to require the conditional distribution of the outcome across each sensitive groups p (y|D=d) to be close to the marginal distribution of the outcome p(y) in a given dataset.

FWC-Fair Wasserstein Coresets: In an exemplary embodiment, given a dataset {Zᵢ}ᵢ₌₁ⁿ, one objective is to find a set of samples {\hat{Z}ⱼ}ⱼ₌₁^{m} and weights {θⱼ}ⱼ₌₁^{m} such that m<<n and that the Wasserstein distance between p_{Z;e} and p_{Zb;θ}, W_{c}(p_{Zb;θ}, p_{Z;w}), is as small as possible. To control for discrimination, fairness constraints are adopted by which it is required that the conditional distribution under the weights {θᵢ}_{i∈[n]} closely aligns with a target distribution p_{Y}_{_{T}} for all possible values of D,

$$J ( {p}_{\hat{Z} ; θ} ( \hat{Y} = y \vert \hat{D} = d ) , {p}_{{Y}_{T}} ( y ) ) \leq ϵ , ∀ d ∈ 𝒟 , y ∈ γ \qquad ( Expression 3 )$$

where J(·, ·) denotes a distance function between distributions and ϵ is a parameter that determines the maximum fairness violation. A shorthand p_{\hat{Z};θ}(y|d) is used for p_{\hat{Z};θ}(Ý=y|\hat{D}=d). J is defined as the subsequent symmetric probability ratio measure:

$$J ( p , q ) = max \{ \frac{p}{q} − 1 , \frac{q}{p} − 1 \} , \qquad ( Expression 4 )$$

which is believed to be a practical measure as it is symmetric with respect to p and q. In an exemplary embodiment, the goal can then be reformulated as the following optimization problem:

$${min}_{θ ∈ {Δ}_{m ,} \hat{Z} ∈ {ℨ}^{m}} {W}_{c} ( {p}_{\hat{Z} ; θ} , {p}_{Z ; e} ) \text{} \qquad ( Expression 5 )$$

$$such that$$

$$J ( {p}_{\hat{Z} ; θ} ( y \vert d ) , {p}_{{Y}_{T}} ( y ) ) \leq ϵ , ∀ d ∈ 𝒟 , y ∈ γ .$$

Here Δₘ is the set of valid weights {θ∈ [symbol] ₊^{m}:Σᵢ₌₁^{m}θᵢ=m}.

In practice, all the possible values of Y and D are known a priori, so the values of Ŷ and \hat{D} can be fixed, thus requiring to optimize only over \hat{X} and θ. The following lemma shows that this in fact does not affect the optimization problem: As the possible values of Yᵢ and Dᵢ are known a priori, and there is only a limited number of them, rather than optimizing over them, the values of Ŷ and \hat{D} are fixed, and optimize only over \hat{X} and θ.

Lemma 1. For any m>0, the best fair Wasserstein coreset formed by m data points {\hat{Z}ᵢ:i∈[m]} is no better than the best fair Wasserstein coreset formed by m|D∥Y| data points {(d, Xᵢ, y)ᵢ:i∈[m], d∈D, y∈Y}. Proof: Once m|D∥Y| data points are generated, the feasible set of the latter Wasserstein coreset contains the feasible set of the former Wasserstein coreset.

Hence, the proportions of {(\hat{D}ᵢ, Ŷ)ᵢ}i∈[m] are set in the coresets to be similar to their respective proportions in the original dataset. The optimization problem then reduces to finding the features in the coreset {\hat{X}ⱼ}ⱼ₌₁^{m} and corresponding weights {θⱼ}ⱼ₌₁^{m} such that:

$${min}_{θ ∈ {Δ}_{m ,} \hat{X} ∈ {𝒳}^{m}} {W}_{c} ( {p}_{\hat{Z} ; θ} , {p}_{Z ; e} ) \text{} \qquad ( Expression 6 )$$

$$such that$$

$$J ( {p}_{\hat{Z} ; θ} ( y \vert d ) , {p}_{{Y}_{T}} ( y ) ) \leq ϵ , ∀ d ∈ 𝒟 , y ∈ γ$$

In an exemplary embodiment, the following steps are then taken to solve the optimization problem in Expression 6:1) First, express the fairness constraints linearly, 2) add artificial variables to the objective function, 3) simplify the optimization problem to obtain a continuous non-convex function of the {Xⱼ}ⱼ₌₁^{m}, and 4) propose a majority minimization to solve the optimization problem.

Step 1—Equivalent linear constraints: Firstly, it is shown that the constraint in Expression 3 can be reformulated as linear constraints on θ of the form Aθ≥0. The conditional probability in Expression 3 can be rewritten as:

$${p}_{\hat{Z} ; θ} ( y \vert d ) = \frac{{\sum }_{i ∈ [ m ] : {\hat{D}}_{i} = d , {\hat{Y}}_{i} = y} {θ}_{i}}{{\sum }_{i ∈ [ n ] : {\hat{D}}_{i} = d} {θ}_{i}} .$$

By substituting the definition of the distance J(·, ·) from Expression 4, the fairness constraints equivalently become linear constraints on {θᵢ}ᵢ₌₁ⁿ via inverting a fractional linear transformation, taking the following form for all d∈D, y∈Y:

$$( Expression 7 )$$

$$\text{?} {\sum }_{i ∈ [ m ] : {\hat{D}}_{i} = d , {\hat{Y}}_{i} = y} {θ}_{i} \leq ( 1 + ϵ ) \cdot {p}_{{Y}_{T}} ( y ) \cdot {\sum }_{i ∈ [ m ] : {\hat{D}}_{i} = d} {θ}_{i}$$

$${\sum }_{i ∈ [ m ] : {\hat{D}}_{i} = d , {\hat{Y}}_{i} = y} {θ}_{i} \geq \frac{1}{1 + ϵ} \cdot {p}_{{Y}_{T}} ( y ) \cdot {\sum }_{i ∈ [ m ] : {\hat{D}}_{i} = d} {θ}_{i} .$$

$$\text{?} \text{indicates text missing or illegible when filed}$$

In total, Expression 7 defines 2|Y∥D| linear constraints on θ in the format of Aθ≥0, where A is a 2|Y∥D|-row matrix. Note that when Y is binary, e.g., Y={0, 1}, half of the linear constraints induced by Expression 3 are redundant and can be removed.

Step 2-Reformulate the objective function by introducing artificial variables: Regarding the objective, when fixing \hat{X}, the objective function of the Wasserstein distance can be equivalently formulated as a linear program with mn variables. Let C(\hat{X}) denote the matrix of the transportation costs, in which the components are defined as follows,

$$( C {{( \hat{X} )}^{def .}}_{ij} = c ( {Z}_{i} , {\hat{Z}}_{j} ) , for i ∈ [ n ] , j ∈ [ m ] .$$

Therefore, now the problem in Expression 6 is equivalent to

$${min}_{\hat{X ∈ {𝒳}^{m} ,} θ ∈ {Δ}_{m ,} P ∈ {ℝ}^{n \times m}} 〈 C ( \hat{X ) , P 〉} \qquad ( Expression 8 )$$

$$such that$$

$$Pe = \frac{1}{n} \cdot {1}_{n} , {P}^{T} e = \frac{1}{m} \cdot θ , P \geq 0 , A θ \geq 0.$$

Step 3. Reduce to optimization problem of \hat{X}. Note that for any feasible (\hat{X}, θ, P) of Expression 8, it holds that θ=m·P^{T}e. Furthermore, given

$$\frac{1}{n} \cdot {1}_{n}^{T} e = 1 , if Pe = \frac{1}{n} \cdot {1}_{n} ,$$

it follows that

$${θ}^{T} e = m \cdot {e}^{T} Pe = \frac{m}{n} \cdot {1}_{n}^{T} e = m .$$

Consequently, Expression 8 is then simplified by replacing variables θ with m·P^{T}e.

$${min}_{Xb ∈ {X}_{m} , P ∈ {R}_{n \times m}} 〈 C ( \hat{X} ) , P 〉 \qquad ( Expression 9 )$$

$$such that$$

$$Pe = \frac{1}{n} \cdot {1}_{n} , P \geq 0 , {AP}^{T} e \geq 0.$$

Define the function F of C by the following optimization problem:

$$F ( C ) {=}^{def .} ( \begin{matrix}{min}_{P ∈ {ℝ}^{n \times m}} & 〈 C , P 〉 \\ \text{s.t.} & Pe = \frac{1}{n} \cdot {1}_{n} , P \geq 0 , A {P}^{T} e \geq 0\end{matrix} ) \qquad ( Expression 10 )$$

and then Expression 9 is equivalent to

$${min}_{\hat{X} ∈ {X}^{m}} F ( C ( \hat{X} ) ) . \qquad ( Expression 11 )$$

Here the objective is continuous but nonconvex with respect to \hat{X}. Once the optimal \hat{X}* is solved, then the optimal P* of Expression 9 is obtained by solving the problem of Expression 10 with C replaced with C(\hat{X}*). Finally, the optimal θ* follows by the equation θ*=m·(P*)^{T}e. A description of a majority minimization method for solving Expression 11 is provided below.

Majority Minimization for Solving the Reformulated Problem: The problem in Expression 10 is a huge-scale linear program with O(n) constraints and O(mn) nonnegative variables. Its size becomes computationally prohibitive for large values of n and m. A fast algorithm for Expression 10 has been proposed, via applying cutting plane methods on the Lagrangian dual problems with reduced dimension. Although this proposal primarily addresses the scenario where m=n, the approach is directly applicable to cases where m≠n. The theoretical complexities of this proposal can also be extended to this setting. Experiments with this proposal have demonstrated that the overall computational complexity of this method is considerably lower than that of interior-point or simplex methods. Following the approach according to this proposal, this directly leads to the following lemmas on computing subgradients and separation oracles, which are going to be used to solve the problem in Expression 10.

Lemma 2: An easily accessible oracle exists for obtaining a minimizer P* for the problem of Expression 10. Lemma 3: The function F(C) is a concave continuous function of C and has easily computed function values and subgradients. Proof: The proof directly uses the concavity of the minimum LP's optimal objective on the cost function. Further, since the feasible set of Expression 10 is bounded, the optimal solution F(C) is continuous with respect to C.

Next, the subgradient at point C is equal to the corresponding optimal solution P* in Expression 10, using a similar proof with Lemma 2. Finally, due to Lemma 2, computing the subgradients the function values of F at C is also feasible.

An approach to solving the problem in Expression 11 by using a majority minimization algorithm is now described. Majority minimization refers to the process of defining a surrogate function that upper bounds the objective function, so that optimizing the surrogate function improves the objective function. A definition is provided for a surrogate function of any \hat{X}^{k}∈X^{m}. Let Pₖ* be the minimizer of Expression 10 with the cost C=C(\hat{X}^{k}), then let

$$g ( \hat{X} ; {\hat{X}}^{k} \} {=}^{def .} 〈 C ( \hat{X} ) , {P}_{k}^{⋆} 〉 . \qquad ( Expression 12 )$$

It is true that g(\hat{X}; \hat{X}^{k})=F(C(\hat{X}) when \hat{X}=\hat{X}^{k}. When \hat{X}≠\hat{X}^{k}, g(\hat{X}; \hat{X}^{k})≥F(C(\hat{X})), which means g(\hat{X}; \hat{X}^{k}) is an upper bound of the objective function F(C(\hat{X})). Moreover, although F(C(\hat{X})) might not be convex with respect to \hat{X}, g(\hat{X}; \hat{X}^{k}), as an upper bound of F(C(\hat{X})), is convex and the minimizer on X^{m},

$${min}_{\hat{X} ∈ {𝒳}^{m}} g ( \hat{X} ; {\hat{X}}^{k} ) \qquad ( Expression 13 )$$

can be efficiently solved. The overall algorithm to minimize the problem in Expression 11 is then summarized in Algorithm 1 below.

Algorithm 1—Majority Minimization for Solving Expression 11:
1) Initial feature vectors \hat{X}^{k} and k=0
2) While True do
3) Update the cost matrix: C←C(\hat{X}^{k})
4) Update the assignment matrix: P* solves Expression 10 via Algorithm 1
5) If \hat{X}^{k}∈argmin x_{b}g(\hat{X}; \hat{X}^{k}) then
6) Return \hat{X}^{k}
7) Else
8) Update the feature vectors of the coreset: \hat{X}^{k+1}←^{argmin}\hat{X}g(\hat{X}; \hat{X}^{k})
9) k←k+1
10) End if
11) End while

It is noted that the problem in Expression 13 can actually be written as the following unconstrained problem:

$${min}_{{\hat{X}}_{i} ∈ 𝒳 : i ∈ m \text{?}} {\sum }_{i ∈ [ m ]} {\sum }_{j ∈ [ n ]} c ( {\hat{Z}}_{i} , {Z}_{j} ) {P}_{ij} \qquad ( Expression 14 )$$

$$\text{?} \text{indicates text missing or illegible when filed}$$

in which each component of P is nonnegative. Furthermore, as shown in Lemma 3, the matrix P is very sparse, sometimes with at most n non-zeros. Moreover, Expression 14 could be separated into the following m problems,

$${min}_{{\hat{X}}_{i} ∈ X} {\sum }_{j ∈ [ n ]} c ( \hat{Z} i , Zj ) Pij for i ∈ [ m ] . \qquad ( Expression 15 )$$

It is noted that each problem is a convex problem so gradient methods could already converge to global minimizers of Expression 15. Furthermore, under some special conditions, it could be solved even more efficiently. 1) If X is convex and

$$c ( Z , \hat{Z} ) {=}^{def .} ‖ Z - \hat{Z} {‖}_{2}^{2} ,$$

then the minimizer of Expression 15 is the weighted average P_{j∈[n]} PᵢⱼXⱼ/P_{j∈[n]} Pᵢⱼ for each i∈[m]. 2) If X is convex and c(Z, \hat{Z})^{def.}=∥Z−\hat{Z}∥₁, then the minimizer of Expression 15 requires sorting the costs coordinate-wisely and finding the median. 3) If creating new feature vectors is not permitted and then X={Xᵢ:i∈[n]}, solving Expression 15 only requires finding the smallest Σ_{j∈[n]}c((d, Xᵢ, y), Zⱼ) Pᵢⱼ over i∈[n]. Note that the matrix P is highly sparse so it is not expensive.

Finally, before providing a convergence result, the following assumption is provided regarding the minimizer of the problem in Expression 11: Assumption 1: The problem

$${min}_{\overline{X} ∈ {X}^{m}} g ( \hat{X} ; \hat{X} k )$$

has a unique minimizer for the optimal solution

The following is a showing of the convergence of Algorithm 1. Lemma 4—Informal convergence results: Under Assumption 1, the objective value is monotonically decreasing, i.e., F(C(\hat{X}^{k+1}))≤F(C(\hat{X}^{k})) for any k≥0. Further, once

$${\hat{X}}^{k} ∈ {arg min}_{\hat{X} ∈ {X}^{m}} g ( \hat{X} ; {\hat{X}}^{k} ) ,$$

then \hat{X}^{k} is a first-order stationary point. Moreover, the algorithm method must terminate within finite iterations. Proof: The monotonically decreasing follows:

$$( Expression 16 )$$

$$F ( C ( {\hat{X}}^{k + 1} ) ) \leq g ( {\hat{X}}^{k + 1} ; {\hat{X}}^{k} ) \leq g ( {\hat{X}}^{k} ; {\hat{X}}^{k} ) = F ( C ( {\hat{X}}^{k} ) ) .$$

To be specific, the inequality in Expression 16 holds strictly when \hat{X}^{k+1}≠\hat{X}^{k}, or equivalently

$${\hat{X}}^{k} ∈ / {arg min}_{\hat{X} ∈ {X}^{m}} g ( \hat{X} ; {\hat{X}}^{k} ) . Once {\hat{X}}^{k} ∈ {arg min}_{\hat{X} ∈ {X}^{m}} g ( \hat{X} ; {\hat{X}}^{k} ) ,$$

then \hat{X}^{k} is already a global minimizer of the convex upper bound g(·; \hat{X}^{k}) for F(C(·)), which means X^{k} is a first-order stationary point of F(C(·)).

As for the finite convergence, there are only finite possible P* as the minimizer of Expression 10. However, before the majority minimization converges, Expression 16 holds strictly. Therefore, after finite iterations, Expression 16 must hold with the inequality holds at equality.

Generalized clustering algorithm: In an alternative exemplary embodiment, when the fairness constraints are absent, the optimization problem in Expression 10 becomes:

$$F ( C ) {=}^{def .} ( \begin{matrix}{min}_{P ∈ {ℝ}^{n \times m}} & 〈 C , P 〉 \\ \text{s.t.} & Pe = \frac{1}{n} \cdot {1}_{n} , P \geq {0}_{n \times m}\end{matrix} ) . \qquad ( Expression 17 )$$

The minimizer P* of the problem of Expression 17 can be written in closed form. For each i∈[n], let Cᵢⱼ_{ᵢ}₊ denote a smallest component on the i-th row of C. Then a minimizer P* can be written as:

$$( Expression 18 )$$

$$P \text{?} {=}^{def .} \{ \begin{matrix}0 , & if j \neq j \text{?} \\ 1 / n , & if j = j \text{?}\end{matrix} for i ∈ [ n ] and ∈ [ m ]$$

$$\text{?} \text{indicates text missing or illegible when filed}$$

Hence, without constraints, FWC corresponds to Lloyd's algorithm for clustering. Specifically, Lloyd's algorithm iteratively computes the centroid for each subset in the partition and subsequently re-partitions the input based on the closeness to these centroids; these are the same operations FWC does in optimizing the surrogate function and solving the problem of Expression 10. Thus, when c(x, y) is correspondingly defined as ∥x−y∥₁ or ∥x−y∥₂², FWC corresponds to Lloyd's algorithm applied to k-medians or k-means problems, except that the centroids have fixed values for \hat{D} and Ŷ.

Accordingly, with this technology, an optimized process for generating synthetic data to be used for downstream learning and training tasks in a manner that accurately represents an original dataset while maintaining demographic parity is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating synthetic data that corresponds to an original dataset while maintaining demographic parity, the method being implemented by at least one processor, the method comprising:
receiving, by the at least one processor, a first dataset that includes a plurality of original data points, each respective original data point including a first coordinate that relates to sensitive demographic features, a second coordinate that relates to decision-making features, and a third coordinate that relates to a decision outcome that is generated by a machine learning model;
determining, by the at least one processor, a demographic parity constraint to be applied to the first dataset;
generating, by the at least one processor, a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model;
computing, by the at least one processor, a set of respective sample-level weights that correspond to each synthetic data point included in the plurality of synthetic data points; and
generating, by the at least one processor, a third dataset by applying the set of respective sample-level weights to the second dataset,
wherein the computing of the set of respective sample weights comprises minimizing, by the at least one processor, a Wasserstein distance between the first dataset and a weighted version of the second dataset while satisfying the demographic parity constraint.

2. The method of claim 1, wherein the first dataset includes a first predetermined number of data points that is equal to N, each of the second dataset and the third dataset includes a second predetermined number of data points that is equal to M, and N is greater than M by at least a factor of ten.

3. The method of claim 1, wherein the determining of the demographic parity constraint comprises selecting a maximum fairness violation threshold value that relates to a distance between a conditional distribution of the third dataset with respect to the third coordinate and a target distribution of the first dataset with respect to the third coordinate.

4. The method of claim 1, further comprising reformulating the minimizing of the Wasserstein distance as a linear program (LP).

5. The method of claim 4, further comprising performing the minimizing of the Wasserstein distance by applying a predetermined majority minimization algorithm to the LP.

6. The method of claim 1, wherein the machine learning model is configured to use an artificial intelligence technique for making a decision based on input data that relates to a person, and wherein the decision relates to at least one from among a consumer finance question, a health insurance question, and a hiring question.

7. The method of claim 1, wherein the sensitive demographic features include at least one from among race, gender, national origin, and disability.

8. The method of claim 1, wherein the decision-making features include at least one from among a level of education, a grade point average (GPA), and a level of income.

9. The method of claim 1, wherein the first dataset includes one from among an Adult dataset, a German Credit dataset, a Communities and Crime dataset, and a Drug dataset.

10. A computing apparatus for generating synthetic data that corresponds to an original dataset while maintaining demographic parity, the computing apparatus comprising:
a processor;
a memory; and
a communication interface coupled to each of the processor and the memory,
wherein the processor is configured to:
receive, via the communication interface, a first dataset that includes a plurality of original data points, each respective original data point including a first coordinate that relates to sensitive demographic features, a second coordinate that relates to decision-making features, and a third coordinate that relates to a decision outcome that is generated by a machine learning model;
determine a demographic parity constraint to be applied to the first dataset;
generate a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model;
compute a set of respective sample-level weights that correspond to each synthetic data point included in the plurality of synthetic data points; and
generate a third dataset by applying the set of respective sample-level weights to the second dataset,
wherein the computation of the set of respective sample rates comprises minimizing a Wasserstein distance between the first dataset and a weighted version of the second dataset while satisfying the demographic parity constraint.

11. The computing apparatus of claim 10, wherein the first dataset includes a first predetermined number of data points that is equal to N, each of the second dataset and the third dataset includes a second predetermined number of data points that is equal to M, and N is greater than M by at least a factor of ten.

12. The computing apparatus of claim 10, wherein the processor is further configured to determine the demographic parity constraint by selecting a maximum fairness violation threshold value that relates to a distance between a conditional distribution of the third dataset with respect to the third coordinate and a target distribution of the first dataset with respect to the third coordinate.

13. The computing apparatus of claim 10, wherein the processor is further configured to reformulate the minimization of the Wasserstein distance as a linear program (LP).

14. The computing apparatus of claim 13, wherein the processor is further configured to performing the minimization of the Wasserstein distance by applying a predetermined majority minimization algorithm to the LP.

15. The computing apparatus of claim 10, wherein the machine learning model is configured to use an artificial intelligence technique for making a decision based on input data that relates to a person, and wherein the decision relates to at least one from among a consumer finance question, a health insurance question, and a hiring question.

16. The computing apparatus of claim 10, wherein the sensitive demographic features include at least one from among race, gender, national origin, and disability.

17. The computing apparatus of claim 10, wherein the decision-making features include at least one from among a level of education, a grade point average (GPA), and a level of income.

18. The computing apparatus of claim 10, wherein the first dataset includes one from among an Adult dataset, a German Credit dataset, a Communities and Crime dataset, and a Drug dataset.

19. A non-transitory computer readable storage medium storing instructions for generating synthetic data that corresponds to an original dataset while maintaining demographic parity, the storage medium comprising executable code which, when executed by a processor, causes the processor to:
receive a first dataset that includes a plurality of original data points, each respective original data point including a first coordinate that relates to sensitive demographic features, a second coordinate that relates to decision-making features, and a third coordinate that relates to a decision outcome that is generated by a machine learning model;
determine a demographic parity constraint to be applied to the first dataset;
generate a second dataset that includes a plurality of synthetic data points, each respective synthetic data point including the first coordinate that relates to the sensitive demographic features, the second coordinate that relates to the decision-making features, and the third coordinate that relates to the decision outcome that is generated by the machine learning model;
compute a set of respective sample-level weights that correspond to each synthetic data point included in the plurality of synthetic data points; and
generate a third dataset by applying the set of respective sample-level weights to the second dataset,
wherein the computation of the set of respective sample-level weights comprises minimizing a Wasserstein distance between the first dataset and a weighted version of the second dataset while satisfying the demographic parity constraint.

20. The storage medium of claim 19, wherein the first dataset includes a first predetermined number of data points that is equal to N, each of the second dataset and the third dataset includes a second predetermined number of data points that is equal to M, and N is greater than M by at least a factor of ten.
